(19) United States
(12) Patent Application Publication
(10) Pub. No.: US 2008/0132616 A1
(43) Pub. Date: Jun. 5, 2008

(54) Stabiliser Composition For Halogen-Containing Thermoplastic Resin Compositions Having An Improved Shelf Life

(76) Inventor: Walter Reith, Egenhofen (DE)

Correspondence Address: FISH & RICHARDSON P.C., P.O BOX 1022, Minneapolis, MN, 55440-1022, US

(21) Appl. No.: 11/568,224

(22) PCT Filed: Apr. 22, 2005
(86) PCT No.: PCT/EP05/04379

§ 371 Date: Aug. 31, 2007

(30) Foreign Application Priority Data
Apr. 23, 2004 (DE) 10 2004 019 947.7

(51) Int. Cl. C08K 5/3492

(52) U.S. Cl. 524/101

(57) ABSTRACT

The present invention is a stabiliser composition for thermoplastic resin compositions, especially for resin compositions based on polyvinyl chloride (PVC), that comprises calcium hydroxide or calcium oxide or a mixture of calcium hydroxide and calcium oxide, at least one β-diketone or a salt of a β-diketone or a mixture thereof and at least one hydroxyl-group-containing isocyanurate or a mixture of two or more hydroxyl-group-containing isocyanurates, wherein component B contains less than 33% by weight, based on component B, of acetylacetone or a salt of acetylacetone or a mixture thereof.

### FIELD OF THE INVENTION

The present invention relates to a stabiliser composition comprising calcium (Ca) and zinc (Zn) for thermoplastic resin compositions, especially for resin compositions based on polyvinyl chloride (PVC).

### BACKGROUND OF THE INVENTION

Halogen-containing polymers are subject to a large number of use-induced or environmentally induced chemical breakdown reactions, for example caused by the action of electromagnetic radiation or heat or combinations of two or more external influences, which may result in lasting impairment of the use properties or even in problems during processing. The breakdown of halogenated polymers, especially PVC, often results in the formation of hydrochloric acid, which is eliminated from the polymer strand, resulting in a discoloured, unsaturated plastics having colour-imparting polyene sequences.

A particular problem in that case is that halogen-containing polymers exhibit the rheological conditions necessary for processing only at a relatively high temperature. At such temperatures, however, in the case of unstabilised polymers the polymer already begins to undergo significant decomposition, which results both in the undesirable colour change described above and in a change in the material properties. Furthermore, the hydrochloric acid freed from non-stabilised, halogen-containing polymers at such a processing temperature can lead to significant corrosion of the processing apparatus. That process plays a role especially when, during the processing of such halogenated polymers to form moulded articles, for example by extrusion, production is interrupted and the polymer mass remains in the extruder for a prolonged period. During that period, the above-mentioned decomposition reactions may occur to a particular extent, so that the material located in the extruder becomes unusable and the extruder may possibly be damaged.

Polymers subject to such a decomposition furthermore tend to adhere to the processing apparatus and the adhering portions are difficult to remove again, and hence adversely affect the production process in terms of its economic efficiency and may have a disadvantageous effect on the quality of the product.

In order to solve the problems mentioned, there are usually added to halogen-containing polymers in the context of processing, as so-called stabilisers, compounds that are intended as far as possible to prevent the above-mentioned decomposition reactions. Such stabilisers are generally solids that are added to the polymer to be processed prior to processing.

The use of calcium hydroxide as a stabiliser for PVC is described, for example, in DE 29 35 689 A1. The combination of overbased alkali metal carboxylates with zeolite, calcium hydroxide and perchlorates is known from EP 0 394 547 B1.

The solution attempts disclosed in accordance with the above-mentioned specifications do not, however, provide conclusively satisfactory stabilisation under highly demanding conditions.

WO 99/55777 describes a stabiliser composition for halogen-containing thermoplastic resin compositions. According to the specification, a mixture of optionally surface-modified calcium hydroxide and/or calcium oxide and a hydroxy-group-containing isocyanurate is proposed for the stabilisation. Whereas the compositions described therein do bring about a clear improvement in the stability of halogen-containing resin compositions compared with the above-cited prior art, the behaviour of the correspondingly stabilised compositions is still not entirely satisfactory in some processing situations. In addition, the surfaces of profiles prepared from such a composition often have irregularities that adversely affect the overall appearance of the profiles. Furthermore, the rheology of the compositions during processing occasionally leaves a great deal to be desired. Especially in cases where importance is attached to as low as possible a content of stabiliser components, in some cases there is still room for improvement in the stabilisation results.

Processing aids are generally essential for the specific adjustment of properties during and after the processing of halogen-containing thermoplastic polymers. Besides the aspect of the frequently not inconsiderable costs incurred for such processing aids, the effect on the overall property profile of a halogen-containing thermoplastic polymer by stabilisers and processing aids is ever more frequently the focus of attention of the processing industry. Increasingly required in the processing of halogen-containing polymers, therefore, are stabilisers that, even when used in small amounts, simultaneously produce excellent processing properties and result in a stability that meets the requirements in question. Although stabiliser systems that achieve good results in the individual areas of stabilisation or of influencing rheology are known from the prior art, the simultaneous establishment of good stabilisation properties and good processing properties often leads to the use of a mixture of stabilisers and further processing aids, in an amount that is too large in terms of the result achieved.

The use of beta-diketones is proposed in the prior art as a means of improving the stabilising properties of stabiliser compositions used for the stabilisation of halogen-containing polymers.

DE 694 29 805 T2, for example, describes the use of beta-diketones as stabilisers for halogen-containing polymers. Further specifications that describe the use of such compounds for stabilising halogen-containing polymers are, for example, U.S. Pat. No. 5,475,145, EP 0 346 279 A1 and EP 0 307 358 A1.

With the action of β-diketones in stabiliser compositions, for example the non prior-published German Patent Application, No. 10352762.1, sets itself apart. The specification discloses that a content of β-diketones or salts thereof of less than 0.5 phr, based on the thermoplastic resin to be stabilised or the thermoplastic resins to be stabilised, has advantageous effects. Although, with a reduced content of β-ketones, the compositions described therein have an effect at least equivalent to the compositions known from the prior art, in cases where storage conditions are especially unfavourable corresponding compositions may so discolour that even the initial colour of a correspondingly stabilised composition comprising at least one halogen-containing polymer deteriorates. Furthermore, in the case of correspondingly unfavourable storage conditions, a discolouration of the stabiliser compositions themselves may even occur, which is found to be unacceptable by the user.

### SUMMARY OF THE INVENTION

The problem underlying the invention is accordingly to provide a stabiliser composition for halogen-containing thermoplastic resins that has adequate thermal stability in comparison with the known formulations. A further problem underlying the invention is to provide a stabiliser composition for halogen-containing thermoplastic resins that exhibits a colour retention at least equivalent to the known formulations. A further problem underlying the invention is to provide a stabiliser composition for halogen-containing thermoplastic resins that is suitable especially for use in PVC-U outdoors. Such a stabiliser composition should, in addition, offer excellent colour stability in the case of thermal stress and stress caused by high-energy radiation, with a view to the use outdoors of moulded articles that have been produced from such a stabilised polymer composition. A further problem underlying the invention is to provide a stabiliser composition for halogen-containing thermoplastic resins that does not exhibit any “plate-out” (deposits in the extruder or calibre) and that is usable on a large number different machines. A further problem underlying the invention is to provide a stabiliser composition for halogen-containing thermoplastic resins that is capable of being used in many different formulations, that is with different types of PVC, different types of chalk, different impact modifiers and using different doses of those additives. Furthermore, a problem underlying the present invention is to provide stabiliser compositions that under extreme storage conditions, for example at high temperature or high humidity or both, cause no or as little as possible discolouration, as well as effect good maintenance of the consistency, of the stabiliser compositions themselves, and cause no or as little as possible a change in the initial colour of a halogen-containing polymer stabilised with such a stabiliser composition.

The problem is solved in accordance with the invention by a stabiliser composition for halogen-containing thermoplastic resins comprising
a) calcium hydroxide or calcium oxide or mixtures thereof, which may optionally be surface-modified,
b) at least one β-diketone or a salt of a β-diketone and
c) at least one hydroxyl-group-containing isocyanurate.

The present invention accordingly relates to a stabiliser composition for stabilising halogen-containing thermoplastic resins comprising
a) calcium hydroxide or calcium oxide or a mixture of calcium hydroxide and calcium oxide as component A and
b) at least one β-diketone or a salt of a β-diketone or a mixture thereof as component B and
c) at least one hydroxyl-group-containing isocyanurate or a mixture of two or more hydroxyl-group-containing isocyanurates as component C,
   wherein component B contains less than 33% by weight, based on component B, of acetylacetone or of a salt of acetylacetone or of a mixture thereof.

### DETAILED DESCRIPTION OF THE PREFERRED EMBODIMENTS

A stabiliser composition according to the present invention is suitable in principle for the stabilisation of compositions that comprise at least one halogen-containing polymer, especially at least one halogen-containing thermoplastic resin. Provision is made in accordance with the invention that a stabiliser composition according to the invention comprises at least one stabilising calcium salt. A suitable stabilising calcium salt is, in principle, any calcium salt that exhibits a stabilising effect on halogen-containing thermoplastic resins, especially a stabilising effect in terms of breakdown phenomena caused by thermal stress, such as occur especially in the processing of such halogen-containing thermoplastic resins.

Suitable as component A is especially calcium oxide or calcium hydroxide or a mixture thereof in essentially any desired form. Calcium oxide or calcium hydroxide are preferably used in powder form. Suitable powders may have essentially any desired size distribution of the powder particles as long as the stabilisation result is not impaired by the particle size distribution selected, or not impaired substantially more than would be tolerable according to the circumstances. The same applies to the BET surface area of the particles used.

For example, within the scope of the present invention, calcium oxide or calcium hydroxide particles are used that have a value D50 for the particle size distribution of approximately 30 μm or less, especially less than approximately 10 μm or less than approximately 5 μm. The secondary particle size (agglomerate size) should not exceed a value of approximately 40 μm. Preferably, the secondary particle size is less than approximately 40 μm, especially less than approximately 30 μm or less than approximately 20 μm.

The calcium oxide or calcium hydroxide particles may optionally be surface-modified in a manner known to the person skilled in the art. Particles surface-modified with stearic acid or 12-hydroxystearic acid are especially suitable.

In accordance with the invention it has been found that especially good results can be achieved when the stabiliser composition contains component A in an amount of from 0.01 to 2 phr, based on the thermoplastic resin to be stabilised or on the thermoplastic resins to be stabilised. Especially suitable amounts of component A lie, for example, within a range of from about 0.05 to about 1.0 phr, or within a range of from about 0.08 to about 0.8 phr. Amounts of, for example, from about 0.1 to about 0.5 phr, for example from about 0.15 to about 0.45 phr or also from about 0.2 to about 0.4 phr or from about 0.25 to about 0.35 phr or from about 0.28 to about 0.32 phr are also suitable. Within the scope of a preferred embodiment of the present invention, the content of component A is from about 0.05 to about 0.3299 phr, based on the thermoplastic resin to be stabilised or the thermoplastic resins to be stabilised.

Besides component A, a composition according to the invention also comprises at least one β-diketone or a salt of a β-diketone or a mixture thereof as component B. That is, a composition according to the invention may comprise, for example, a β-diketone or a mixture of two or more β-diketones, or a salt of a β-diketone or a mixture of two or more salts of a β-diketone or a mixture of two or more salts of two or more β-diketones or a mixture of a β-diketone and a salt of a β-diketone or a mixture of two or more β-diketones and a salt of a β-diketone or a mixture of two or more β-diketones and a mixture of two or more salts of a β-diketone or a mixture of two or more β-diketones and a mixture of two or more salts of two or more β-diketones or a mixture of a β-diketone and a mixture of two or more salts of a β-diketone or a mixture of a β-diketone and a mixture of two or more salts of two or more β-diketones.

In the context of the present invention it has been found, however, that, in comparison with stabiliser compositions as known from the prior art, the storage stability of stabiliser compositions according to the invention stand out by virtue of their improved properties when the proportion of acetylacetone or of salts of acetylacetone or of a mixture of two or more thereof is less than 33% by weight of the total of component B.

There are suitable as β-diketones, for example, compounds of the general formula I

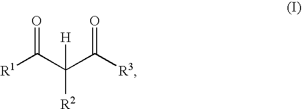

wherein R¹ and R³ are each independently of the other an unsubstituted or substituted, linear or branched alkyl or alkenyl group having from 1 to 30 carbon atoms, an unsubstituted or substituted aralkyl group having from 7 to 31 carbon atoms, an unsubstituted or substituted aryl or heteroaryl group having from 3 to 14 carbon atoms in the ring, or an unsubstituted or substituted cycloalkyl group having from 3 to 18 carbon atoms or, each independently of the others, R¹ or R³ may be O—R¹ or HN—R¹ and R² is O—R¹ or COOH or an unsubstituted or substituted, linear or branched alkyl group having from 1 to 24 carbon atoms, or each of R¹ or R³ or R¹ and R³ together with R² form an unsubstituted or substituted, cycloaliphatic or heterocycloaliphatic ring having, each independently of the other, from 3 to 18 carbon atoms, and salts thereof.

As already made clear in the context of the present text, the action according to the invention arises when the proportion of acetylacetone or of salts thereof or of a mixture of acetylacetone and salts thereof in component B is 33% by weight or less. Preferably, that proportion is less than about 25, less than about 20, less than about 15, less than about 13, less than about 10, less than about 5, less than about 3, less than about 2, less, for instance, than about 1, less than about 0.5, less than about 0.1 or less than about 0.05% by weight. Within the scope of a further preferred embodiment of the present invention, component B is substantially free of acetylacetone or salts thereof, that is, the proportion of acetylacetone in component B or salts thereof or of a mixture of two or more thereof is less than about 0.01% by weight, for example in the range from about 0.001 to less than about 0.01% by weight or below.

In the context of the present invention, therefore, preferably at least one of the radicals R¹ or R³ in the above general formula I is not a CH₃ group.

In principle, suitable substituents are any substituents that do not adversely affect, or do not adversely affect more than would be tolerable, the effects achieved with the aid of the β-diketones in respect of stabilisation of and processing properties of the polymers being stabilised. Suitable substituents are, for example, OH groups, keto groups, halogen atoms, such as F, Cl or Br, alkyl groups, cycloalkyl groups or aryl groups. Suitable compounds that fall within the general formula I and that can be used in the context of the present invention are, for example, propionylacetylmethane butyroylacetylmethane, pentanoylacetylmethane, hexanoylacetylmethane, heptanoylacetylmethane, triacetylmethane, benzoylacetylmethane, dimedone, acetyltetralone, palmitoyltetralone, stearoyltetralone, benzoyltetralone, 2-acetylcyclohexanone, 2-benzoylcyclohexanone, 2-acetylcyclohexanone-1,3-dione, bis(4-methylbenzoyl)methane, bis(2-hydroxybenzoyl)methane, tribenzoylmethane, diacetylbenzoylmethane, stearoylbenzoylmethane, palmitoylbenzoylmethane, diacetylbenzoylmethane, dibenzoylmethane, 4-methoxybenzoylbenzoylmethane, bis(3,4-methylenedioxybenzoyl)methane, benzoylacetyloctylmethane, benzoylacetylphenylmethane, stearoyl-4-methoxybenzoylmethane, bis(4-tert.-butylbenzoyl)methane, benzoylacetylethylmethane, benzoyltrifluoroacetylmethane, distearoylmethane, stearoylacetylmethane, palmitoylacetylmethane, lauroylacetylmethane, benzoylformylmethane, acetylformylmethylmethane, benzoylacetylphenylmethane, bis(cyclohexanoyl(2))methane and the like. Diacetylmethane (acetylacetone) may be present in a stabiliser composition according to the invention within the limits indicated above. Preferably, the proportion of acetylacetone or salts thereof in a stabiliser composition according to the invention is, however, as low as possible; it is especially preferred for the stabiliser compositions according to the invention to be substantially free of acetylacetone.

Suitable salts of those compounds are, for example, salts with alkali metals, alkaline earth metals or suitable transition metals. Suitable salts are, for example, the salts of the above-mentioned compounds with Li, Na, K, Ba, Ca, Mg, Zn, Zr, Ti, Sn or Al. Of the salts of compounds of the general formula I, preference is given especially to the salts with Ca or Zn or mixtures thereof.

β-Diketones suitable in accordance with the invention are, for example, stearoylbenzoylmethane, dibenzoylmethane or commercially obtainable β-diketones such as P24 (Akcross) or mixtures of two or more thereof.

In the context of the present invention, special preference is given to the salts of β-diketones having a melting point of less than about 150° C., especially having a melting point of less than about 120° C., for example somewhat less than about 80° C., less than about 60° C. or about 50° C. or less.

The amount of component B present in a stabiliser composition according to the invention is preferably from about 0.01 to about 2 phr, based on the thermoplastic resin to be stabilised or the thermoplastic resins to be stabilised. Amounts that are especially suitable lie, for example, within a range from about 0.03 to about 1.5 phr or from about 0.05 to about 1.2 phr or from about 0.08 to about 1 phr or from about 0.1 to about 0.9 phr or from about 0.15 to about 0.8 phr or from about 0.2 to about 0.7 phr. The content of component B is preferably about 0.2 to 0.6 phr, for example from about 0.3 to about 0.55 phr, based on the halogen-containing thermoplastic resin to be stabilised or the halogen-containing thermoplastic resins to be stabilised.

Within the scope of a further preferred embodiment of the present invention, a stabiliser composition according to the invention contains calcium acetylacetonate or zinc acetylacetonate or a mixture thereof in an amount of less than about 0.3 phr, based on the thermoplastic resins to be stabilised. Especially preferred amounts for the content of Ca-acetylacetonate or Zn-acetylacetonate or a mixture thereof are, for example, less than about 0.1 phr or less than about 0.05 or less than about 0.01 or less than about 0.005 or less than about 0.001 phr, for example less than about 0.001 or less than about 0.0001 phr, based on the halogen-containing polymer to be stabilised.

Besides components A and B, a stabiliser composition according to the invention comprises at least one further compound. In order to improve the stabilising effect, it has proved advantageous in accordance with the invention for a stabiliser composition according to the invention to comprise at least one hydroxyl-group-carrying isocyanurate as component C.

In the context of the present invention, in principle there are suitable as component C any isocyanurates that contain at least one OH group. Within the scope of a preferred embodiment of the present invention, however, isocyanurates are used that contain at least two OH groups. In the context of the present invention, preference is given, however, to the use of isocyanurates that contain three OH groups.

Within the scope of an especially preferred embodiment of the present invention, the hydroxyl-group-containing isocyanurate is selected from compounds of the general formula (II)

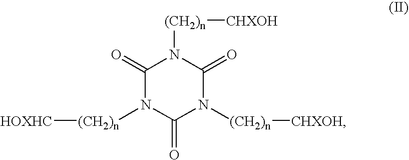

wherein the groups X and the indices n are identical or different, and n is an integer from 0 to 5 and X is a hydrogen atom or a linear or branched alkyl group having from 1 to 6 carbon atoms.

Of those there are especially preferred tris(hydroxyethyl)isocyanurate (referred to as THEIC hereinafter) and hindered phenolic isocyanurates according to EP 0 685 516 B1, to the disclosure of which reference is expressly made in respect of the corresponding hindered phenolic isocyanurates, and the disclosure of which relating to such isocyanurates is understood as part of the disclosure of the present text.

The amount of component C preferably present in a stabiliser composition according to the invention is from about 0.01 to about 3 phr, based on the thermoplastic resin to be stabilised or the thermoplastic resins to be stabilised. Especially suitable amounts lie, for example, within a range of from about 0.03 to about 2 phr or from about 0.05 to about 1.5 phr or from about 0.06 to about 1 phr or from about 0.07 to about 0.8 phr or from about 0.08 to about 0.59 phr or from about 0.09 to about 0.5 phr or from about 0.1 to about 0.3 phr.

The content of components A, B and C in the stabiliser composition, based on the stabiliser composition overall, is from about 0.5 to about 80% by weight. Preferably, the content of components A, B and C in such a case is from about 1 to about 65% by weight, for example from about 5 to about 50% by weight.

The proportion of component A in the stabiliser composition lies, for example, within a range of from about 0.1 to about 30% by weight or from about 1 to about 25% by weight or from about 3 to about 20% by weight or from about 5 to about 15% by weight or from about 7 to about 12% by weight or from about 8 to about 11% by weight, in each case based on the total weight of the stabiliser composition.

The proportion of component B in the stabiliser composition lies, for example, within a range of from about 0.01 to about 30% by weight or from about 0.1 to about 28% by weight or from about 0.5 to about 22% by weight or from about 1 to about 20% by weight or from about 2 to about 18% by weight, in each case based on the total weight of the stabiliser composition.

The proportion of component C in the stabiliser composition lies, for example, within a range of from about 0.01 to about 30% by weight or from about 0.1 to about 20% by weight or from about 0.5 to about 15% by weight or from about 1 to about 12% by weight or from about 2 to about 10% by weight or from about 2.5 to about 9.9% by weight or about 2.75 to 8% by weight or from about 3 to about 7% by weight or about 3.5 to 6.5% by weight, in each case based on the total weight of the stabiliser composition.

In terms of the stabilising effect, a stabiliser combination according to the invention has proved especially advantageous when a particular ratio is adhered to. Thus, for example, in the context of the present invention, within the scope of a preferred embodiment the ratio of β-diketones to compounds of component C should be at least 1, preferably more than 1. Especially suitable ratios lie, for example, within a range of from about 1 to about 2, especially from about 1.1 to about 1.5 or from about 1.2 to about 1.45 or from about 1.3 to about 1.4.

A stabiliser composition according to the invention preferably meets one or more of the following conditions:
(i) the content of component A is from 0.01 to 0.8 phr, based on the thermoplastic resin to be stabilised or the thermoplastic resins to be stabilised,
(ii) the content of component B is from 0.01 to 0.6 phr, based on the thermoplastic resin to be stabilised or the thermoplastic resins to be stabilised,
(iii) the content of component C is from 0.01 to 0.59 phr, based on the thermoplastic resin to be stabilised or the thermoplastic resins to be stabilised,
(iv) the content of component A is from 0.1 to 12% by weight, based on the total weight of the stabiliser composition,
(v) the content of component B is from 0.1 to 18% by weight, based on the total weight of the stabiliser composition,
(vi) the content of component C is from 0.1 to 15% by weight, based on the total weight of the stabiliser composition,
(vii) the ratio by weight of component B to component C is more than 1.

While a content of the above-mentioned components A, B and C in a stabiliser composition according to the invention that is preferably within the above-mentioned limits already leads to good stabilisation results with a surprisingly good storage stability, it has furthermore proved advantageous in terms of enhancement of the stabilising effect when the stabiliser composition according to the invention comprises a hydrotalcite or a mixture of two or more hydrotalcites.

In the context of the present invention, a suitable hydrotalcite is, in principle, any kind of hydrotalcite that at least exhibits no adverse effect, or at any rate substantially no adverse effect, in terms of the processing properties and/or the stabilisation of a halogen-containing polymer in the context of a stabiliser composition according to the invention. Furthermore, special preference is given to those hydrotalcites that do not adversely affect the storage stability of a stabiliser composition according to the invention. Especially suitable, for example, are hydrotalcites such as are described in the specifications WO 96/02465 A1 (especially pages 3 to 7 and Examples), EP 0 189 899 (especially pages 10-15, Tables 2 to 10), DE 38 43 581 (especially page 4), U.S. Pat. No. 4,883,533 (especially columns 2-4, Examples), EP 0 407 139 A2 (especially pages 2-3, Examples), DE 40 31 818 A1 (especially pages 2-3), DE 41 10 835 A1 (especially columns 2-5, Examples), DE 41 17 034 A1 (especially pages 2-6, Examples), EP 0 522 810 A2 (especially pages 2-3), DE 44 39 934 A1 (especially pages 2-3, Examples) and U.S. Pat. No. 5,352,723 (especially columns 2-3, Examples). Reference is expressly made to the disclosure of the above-mentioned specifications, especially to the disclosure at the locations mentioned, the corresponding disclosure of the specifications being understood as part of the disclosure of the present text.

It has also proved advantageous when a stabiliser composition according to the invention comprises at least one zinc salt, preferably a zinc salt of an organic carboxylic acid. In that connection, however, it is especially advantageous when a stabiliser composition according to the invention comprises a mixture of at least one zinc salt of an organic carboxylic acid having 16 or more carbon atoms and at least one zinc salt of an organic acid having fewer than 16 carbon atoms.

Suitable organic carboxylic acids are, for example, caproic acid, caprylic acid, capric acid, lauric acid, myristic acid, oenanthic acid, octanoic acid, neodecanoic acid, 2-ethylhexanoic acid, pelargonic acid, decanoic acid, undecanoic acid, dodecanoic acid, tridecanoic acid, palmitic acid, lauryl acid, linoleic acid, linolenic acid, erucic acid, isostearic acid, stearic acid, 12-hydroxystearic acid, 9,10-dihydroxystearic acid, oleic acid, 3,6-dioxaheptanoic acid, 3,6,9-trioxadecanoic acid and behenic acid.

Advantageously, the ratio of zinc salt or of a mixture of two or more zinc salts of carboxylic acids having 16 or more cabon atoms to zinc salt or a mixture of two or more zinc salts of carboxylic acids having fewer than 16 carbon atoms is from about 1:100 to about 100:1, especially from about 1:10 to about 10:1.

Within the scope of a preferred embodiment of the present invention, a stabiliser composition according to the invention comprises a mixture of zinc stearate and at least one further organic zinc salt, wherein the at least one further organic zinc salt is preferably a zinc salt of an organic carboxylic acid having fewer than 16 carbon atoms. An especially preferred mixture in that embodiment is a mixture of zinc stearate and zinc caprylate or a mixture of zinc stearate and zinc 12-oxystearate or a mixture of zinc stearate and zinc caprylate and zinc 12-oxystearate.

Preferably, the proportion of a mixture of two or more of the above-mentioned zinc salts in the stabiliser composition according to the invention is from about 0.1 to about 5 phr, based on the amount of halogen-containing polymer to be stabilised, for example from about 0.2 to about 2 phr or from about 0.8 to about 1.2 phr.

It has furthermore proved advantageous for the processing and stabilising properties of the present stabiliser composition according to the invention when the stabiliser composition comprises a triglyceride. Suitable triglycerides in that connection are any triglycerides that at least do not adeversely affect the processing properties of a polymer composition that comprises a stabiliser composition according to the invention.

Suitable triglycerides are, for example, natural or synthetic fats. The use of triglycerides together with the above-mentioned compounds in a stabiliser composition according to the invention has, in accordance with the invention, proved to lead to an improvement in the surface structure during extrusion. Further advantageous effects are good resistance to hydrolysis, rapid gelling, an ability to bind to large amounts of fillers, and no plate-out effect.

Especially suitable are glycerol stearates, such as purified beef tallow, hydrogenated beef tallow, purified or hydrogenated fish oil or glycerol (tri-12-hydroxystearate), such as hydrogenated castor oil or mixtures of two or more of the mentioned compounds. Hydrogenated beef tallow and hydrogenated castor oil are especially suitable.

The stabiliser combination according to the invention may, in addition, comprise at least one further additive or a mixture of two or more of the said additives. The additives mentioned below may be present in an amount altogether of from about 2 to about 99.9% by weight, based on the total stabiliser composition. Preferably, a stabiliser composition according to the invention contains altogether from about 0.1 to about 2 phr of components A, B and C.

Also suitable as additives are, for example, further amino alcohols. Suitable amino alcohols in the context of the present invention are in principle any compounds having at least one OH group and a primary, secondary or tertiary amino group or a combination of two or more of the mentioned amino groups. In principle, in the context of the present invention both solid and liquid amino alcohols are suitable as a constituent of the stabiliser compositions according to the invention. In the context of the present invention, the proportion of liquid amino alcohols, however, is, for example, so chosen that the stabiliser composition overall is substantially in solid form.

Within the scope of a preferred embodiment of the present invention, amino alcohols that can be used in the context of the present invention have a melting point higher than about 30° C., especially higher than about 50° C. Suitable amino alcohols are, for example, mono- or poly-hydroxy compounds that are based on linear or branched, saturated or unsaturated aliphatic mono- or poly-amines.

There are suitable in that connection, for example, OH-group-carrying derivatives of primary mono- or poly-amino compounds having from 2 up to about 40, for example from 6 up to about 20, carbon atoms. Examples thereof are corresponding OH-group-carrying derivatives of ethylamine, n-propylamine, isopropylamine, n-propylamine, sec-propylamine, tert-butylamine, 1-aminoisobutane, and substituted amines having from 2 to about 20 carbon atoms, such as 2-(N,N-dimethylamino)-1-aminoethane. Suitable OH-group-carrying derivatives of diamines are, for example, those based on diamines having a molecular weight of from about 32 to about 200 g/mol, the corresponding diamines having at least two primary, two secondary, or one primary and one secondary amino group(s). Examples thereof are diaminoethane, diaminopropane isomers, diaminobutane isomers, diaminohexane isomers, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines, such as diethylenetriamine or 1,8-diamino-4-aminomethyloctane, triethylamine, tributylamine, dimethylbenzylamine, N-ethyl-, N-methyl-, N-cyclohexyl-morpholine, dimethylcyclohexylamine, dimorpholinodiethyl ether, 1,4-diazabicyclo[2.2.2]octane, 1-1-azabicyclo[3.3.0]octane, N,N,N′,N′-tetramethylethylenediamine, N,N,N′,N′-tetramethylbutanediamine, N,N,N′,N′-tetramethyl-1,6-hexanediamine, pentamethyldiethylenetriamine, tetramethyldiaminoethyl ether, bis(dimethylaminopropyl)urea, N,N′-dimethylpiperazine, 1,2-dimethylimidazole and di(4-N,N-dimethylaminocyclohexyl)methane.

Especially suitable are aliphatic amino alcohols having from 2 to about 40, preferably from 6 to about 20, carbon atoms, for example 1-amino-3,3-dimethyl-pentan-5-ol, 2-aminohexane-2′,2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentane-methanol, 2-amino-2-ethyl-1,3-propanediol, 2-(dimethylaminoethoxy)-ethanol, aromatic-aliphatic or aromatic-cycloaliphatic amino alcohols having from 6 to about 20 carbon atoms, there coming into consideration as aromatic structures heterocyclic or isocyclic ring systems such as naphthalene derivatives or, especially, benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol, and also mixtures of two or more such compounds.

Also suitable as additives in the context of the present invention are compounds having a structural element as shown in the general formula III

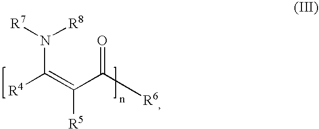

wherein n is a number from 1 to 100,000, the radicals R⁷, R⁸, R⁴ and R⁵ are each independently of the others hydrogen, an unsubstituted or substituted, linear or branched, saturated or unsaturated aliphatic alkyl radical having from 1 to 44 carbon atoms, an unsubstituted or substituted, saturated or unsaturated cycloalkyl radical having from 6 to 44 carbon atoms or an unsubstituted or substituted aryl radical having from 6 to 44 carbon atoms or an unsubstituted or substituted aralkyl radical having from 7 to 44 carbon atoms, or the radical R⁴ is an unsubstituted or substituted acyl radical having from 2 to 44 carbon atoms or the radicals R⁴ and R⁵ are bonded to an aromatic or heterocyclic system, and wherein the radical R⁶ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted, saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 oxygen or sulphur atoms or oxygen and sulphur atoms, or a polymer that is bonded by way of O, S, NH, NR⁴ or CH₂C(O) to the structural element enclosed in brackets, or the radical R⁶ is so linked to the radical R⁴ that in total an unsubstituted or substituted, saturated or unsaturated heterocyclic ring system having from 4 to 24 carbon atoms is formed, or a mixture of two or more compounds of the general formula III.

Within the scope of a preferred embodiment of the present invention, the compound of the general formula III used is a compound based on an α,β-unsaturated β-aminocarboxylic acid, especially a compound based on β-aminocrotonic acid. Especially suitable are the esters or thioesters of corresponding aminocarboxylic acids with monohydric or polyhydric alcohols or mercaptans.

An exact description of the compounds of the general formula III that can be used in the context of the present invention may be found on pages 7 to 10 of WO 02/068526, reference being expressly made to that specification and to the corresponding disclosure, and the disclosure being regarded as part of the disclosure of the present text.

Also suitable as additives are compounds having at least one mercapto-functional sp²-hybridised carbon atom, such as are described on pages 10 and 11 of WO 02/068526. Reference is expressly made to that specification and to the corresponding disclosure, and the disclosure is regarded as part of the disclosure of the present text.

A stabiliser composition according to the invention may furthermore comprise fillers, such as are described on pages 393-449 of “Handbook of PVC Formulating”, E. J. Wickson, John Wiley & Sons, Inc., 1993, or reinforcing agents, such as are described on pages 549-615 of “Taschenbuch der Kunststoffadditive”, R. Gächter/H. Müller, Carl Hanser Verlag, 1990, or pigments.

Also suitable as additives are salts of halogen-containing oxyacids, especially perchlorates. Examples of suitable perchlorates are those of the general formula M(ClO₄)ₙ, wherein M is Li, Na, K, Mg, Ca, Sr, Zn, Al, La or Ce. The index n, according to the valency of M, is the number 1, 2 or 3. The mentioned perchlorate salts may be complexed with alcohols (polyols, cyclodextrins) or ether alcohols or ester alcohols. The ester alcohols also include polyol partial esters. In the case of polyhydric alcohols or polyols, there also come into consideration dimers, trimers, oligomers and polymers thereof, such as di-, tri-, tetra- and poly-glycols as well as di-, tri- and tetra-pentaerythritol or polyvinyl alcohol in different degrees of polymerisation and hydrolysis. Preferred as polyol partial esters are glycerol monoethers and glycerol monothioethers. Sugar alcohols or thiosugars are also suitable.

The perchlorate salts in this context may be used in various common forms of preparation, for example in the form of a salt or aqueous solution, applied to a suitable carrier material, such as PVC, calcium silicate, zeolite, calcium hydroxide, calcium oxide or hydrotalcites, or bound in a hydrotalcite by chemical reaction. In respect of perchlorate compounds applied to calcium oxide or calcium hydroxide, reference is expressly made to DE 101 24 734 A1, the disclosure of that specification with respect to supported perchlorates being regarded as part of the disclosure of the present text.

Also suitable as additives are, for example, basic calcium aluminium hydroxyphosphites of the general formula (IV)

CaₓAl₂(OH)_{2(x+3-y)}(HPO₃)_{y}*mH₂O (IV),

wherein 2≦x≦12, (2x+5)/2>y>0 and 0≦m≦12. Compounds of the general formula (IV) are described, for example, in DE 41 06 411 A. Further basic calcium aluminium hydroxyphosphites are described in DE-A-3941902. Reference is expressly made to the disclosure of the mentioned specifications in respect of basic calcium aluminium hydroxyphosphites. The disclosure is regarded as part of the disclosure of the present text.

Also suitable as additives in the context of the stabiliser compositions according to the invention are basic calcium aluminium hydroxycarboxylates of the general formula V

CaₓAl₂(OH)_{[(2x+6)-y]}A_{y/n}ⁿ⁻*mH₂O (V),

wherein 2≦x≦12, (2x+5)/2>y>0, 0≦m≦12 and 1≦n≦8, and Aⁿ⁻ is an aliphatic, saturated, unsaturated, straight-chain or branched, mono- or poly-functional carboxylic acid anion having from 1 to 22 carbon atoms or is an aromatic or heteroaromatic mono- or poly-functional carboxylic acid anion having from 6 to 20 carbon atoms.

The carboxylic acid anion Aⁿ⁻ in the general formula (V) may be selected, for example, from anions of malonic, succinic, adipic, fumaric, maleic, phthalic, isophthalic, terephthalic, pyridinic, benzoic, salicylic, tartronic, malic, tartaric, acetonedicarboxylic, oxalacetic, aconitic and citric acid. The anions of fumaric and phthalic acid are preferred; fumarates, especially, are used.

Compounds of the general formula (V) are known, for example, from DE 41 06 404 A. Further calcium aluminium hydroxycarboxylates are described in DE 40 02 988 A, reference being expressly made to the disclosure of those specifications in respect of the said calcium aluminium hydroxycarboxylates and the disclosure thereof being part of the disclosure of the present text.

Also suitable as additives in the context of the stabiliser composition according to the invention are polyols. Suitable polyols are, for example, pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, lycasine, mannitol, lactose, leucrose, tris(hydroxymethyl) isocyanurate, palatinite, tetramethylolcyclohexanol, tetramethylolcyclopentanol, tetramethylolcycloheptanol, glycerol, diglycerol, polyglycerol, thiodiglycerol or 1-0-α-D-glycopyranosyl-D-mannitol dihydrate.

Also suitable as additives are, for example, epoxy compounds. Examples of such epoxy compounds are epoxidised soybean oil, epoxidised olive oil, epoxidised linseed oil, epoxidised castor oil, epoxidised groundnut oil, epoxidised maize oil, epoxidised cottonseed oil, and also glycidyl compounds. Suitable glycidyl compounds are especially the glycidyl compounds as described on pages 20 to 22 of WO 02/068526. Reference is expressly made to the disclosure of the mentioned specification in respect of glycidyl compounds and it is regarded as part of the disclosure of the present text.

Especially suitable epoxy compounds are described, for example, on pages 3 to 5 of EP-A 1 046 668, reference being expressly made to the disclosure contained therein, which is regarded as part of the disclosure of the present text.

Also suitable as additives are, for example, zeolites, which can be described by the general formula Mₓⁿ[(AlO₂)ₓ(SiO₂)_{y}]*m H₂O wherein n represents the charge of the cation M (e.g. alkali metal or alkaline earth metal), 0.8≦x, y≦15 and 0≦m≦300.

There are likewise suitable as additives, for example, sterically hindered amines, such as are mentioned on pages 7 to 27 of EP-A 1 046 668. Reference is expressly made to the sterically hindered amines disclosed therein; the compounds mentioned are regarded as part of the disclosure of the present text.

Also suitable as additives are uracils and aminouracils, as mentioned, for example, in EP 1 046 668. The disclosure that relates to aminouracils of the mentioned specification is regarded as part of the disclosure of the present text.

Also suitable as additives are amino acids and alkali metal and alkaline earth metal salts.

Likewise suitable as additives are hydrocalumites of the general formula AlCaₓ(OH)₂ₓ₊₃*m H₂O; x=1 to 4; m=0 to 8, which are described, for example, in DE 41 03 881. Reference is expressly made to the mentioned specification and to the disclosure thereof in respect of the mentioned hydrocalumites, and the disclosure is regarded as part of the disclosure of the present text.

A stabiliser composition according to the invention may furthermore comprise as additive an organotin compound or a mixture of two or more organotin compounds. Suitable organotin compounds are, for example, methyltin-tris(isooctyl-thioglycolate), methyltin-tris(isooctyl-3-mercaptopropionate), methyltin-tris(isodecyl-thioglycolate), dimethyltin-bis(isooctyl-thioglycolate), dibutyltin-bis(isooctyl-thioglycolate), monobutyltin-tris(isooctyl-thioglycolate), dioctyltin-bis(isooctyl-thioglycolate), monooctyltin-tris(isooctyl-thioglycolate) or dimethyltin-bis(2-ethylhexyl-β-mercaptopropionate).

Furthermore, in the context of the stabiliser compositions according to the invention it is possible to use the organotin compounds that are mentioned on, and the preparation of which is described on, pages 18 to 29 of EP-A 0 742 259. Reference is expressly made to the above-mentioned disclosure, the compounds mentioned therein and their preparation being understood as being part of the disclosure of the present text. Likewise suitable as additives are latent mercaptans, such as are described in EP 0 742 259 A1 and EP 1 201 706 A1, as well as cyanoacetylureas according to DE 299 24 285 U1, reference being expressly made to the above-mentioned disclosure locations, and the compounds mentioned therein and the preparation thereof being understood as being part of the disclosure of the present text.

Within the scope of a further embodiment of the present invention, a stabiliser composition according to the invention may comprise organic phosphite esters having from 1 to 3 organic radicals, two or more of which radicals may be identical or all of which may be different. Suitable organic radicals are, for example, linear or branched, saturated or unsaturated alkyl radicals having from 1 to 24 carbon atoms, unsubstituted or substituted alkyl radicals having from 6 to 20 carbon atoms and unsubstituted or substituted aralkyl radicals having from 7 to 20 carbon atoms. Examples of suitable organic phosphite esters are tris(nonylphenyl), trilauryl, tributyl, trioctyl, tridecyl, tridodecyl, triphenyl, octyldiphenyl, dioctylphenyl, tri(octylphenyl), tribenzyl, butyldicresyl, octyl-di(octylphenyl), tris(2-ethylhexyl), tritolyl, tris(2-cyclohexylphenyl), tri-α-naphthyl, tris(phenylphenyl), tris(2-phenylethyl), tris(dimethylphenyl), tricresyl or tris(p-nonylphenyl) phosphite or tristearyl sorbitol-triphosphite or mixtures of two or more thereof.

A stabiliser composition according to the invention may also comprise glidants, such as montan wax, fatty acid esters, polyethylene waxes, amide waxes, chloroparaffins or alkaline earth soaps. Glidants suitable for use as additives are also described in “Kunststoffadditive”, R. Gächter/H. Müller, Carl Hanser Verlag, 3rd edition, 1989, pages 478-488. Also suitable as additives are, for example, fatty ketones, such as are described in DE 4,204,887, and also silicone-based glidants, such as are mentioned, for example, in EP A 0 259 783, or combinations thereof, such as are mentioned in EP-A 0 259 783. Reference is expressly made to the mentioned documents, the disclosure of which relating to glidants is regarded as being part of the disclosure of the present text.

Likewise suitable as additives for stabiliser compositions according to the present invention are organic plasticisers.

As corresponding plasticisers there are suitable, for example, the compounds, mentioned above in the context of the description of solvents, from the group of phthalic acid esters, such as dimethyl, diethyl, dibutyl, dihexyl, di-2-ethylhexyl, di-n-octyl, diisooctyl, diisononyl, diisodecyl, dicyclohexyl, dimethylcyclohexyl, dimethyl glycol, dibutyl glycol, benzylbutyl or diphenyl phthalate and also mixtures of phthalates, for example mixtures of alkyl phthalates having from 7 to 9 or 9 to 11 carbon atoms in the ester alcohol or mixtures of alkyl phthalates having from 6 to 10 and 8 to 10 carbon atoms in the ester alcohol. Especially suitable in the sense of the present invention are dibutyl, dihexyl, di-2-ethylhexyl, di-n-octyl, diisooctyl, diisononyl, diisodecyl, diisotridecyl and benzylbutyl phthalate and also the mentioned mixtures of alkyl phthalates.

Also suitable as plasticisers are the esters of aliphatic dicarboxylic acids, especially the esters of adipic, azelaic or sebacic acid or mixtures of two or more thereof. Examples of such plasticisers are di-2-ethylhexyl adipate, diisooctyl adipate, diisononyl adipate, diisodecyl adipate, benzylbutyl adipate, benzyloctyl adipate, di-2-ethylhexyl azelate, di-2-ethylhexyl sebacate and diisodecyl sebacate. Within the scope of a further embodiment of the present invention preference is given to di-2-ethylhexyl acetate and diisooctyl adipate.

Also suitable as plasticisers are trimellitic acid esters, such as tri-2-ethylhexyl trimellitate, triisotridecyl trimellitate, triisooctyl trimellitate and also trimellitic acid esters having from 6 to 8, 6 to 10, 7 to 9 or 9 to 11 carbon atoms in the ester group or mixtures of two or more of the mentioned compounds.

Further suitable plasticisers are, for example, polymer plasticisers, such as are mentioned in “Kunststoffadditive”, R. Gächter/H. Müller, Carl Hanser Verlag, 3rd edition, 1989, chapter 5.9.6, pages 412-415, or “PVC Technology”, W. V. Titow, 4th Edition, Elsevier Publishers, 1984, pages 165-170. The most customary starting materials for the preparation of polyester plasticisers are, for example, dicarboxylic acids, such as adipic, phthalic, azelaic or sebacic acid and also diols, such as 1,2-propanediol, 1,3-butanediol, 1,4-butanediol, 1,6-hexanediol, neopentyl glycol or diethylene glycol or mixtures of two or more thereof.

Also suitable as plasticisers are phosphoric acid esters, as may be found in “Taschenbuch der Kunststoffadditive”, chapter 5.9.5, pages 408-412. Examples of suitable phosphoric acid esters are tributyl phosphate, tri-2-ethylbutyl phosphate, tri-2-ethylhexyl phosphate, trichloroethyl phosphate, 2-ethyl-hexyl-di-phenyl phosphate, triphenyl phosphate, tricresyl phosphate and trixylenyl phosphate, or mixtures of two or more thereof.

Also suitable as plasticisers are chlorinated hydrocarbons (paraffins) or hydrocarbons such as are described in “Kunststoffadditive”, R. Gächter/H. Müller, Carl Hanser Verlag, 3^{rd} edition, 1989, chapter 5.9.14.2, pages 422-425, and chapter 5.9.14.1, page 422.

Within the scope of a further embodiment of the present invention, the stabiliser compositions according to the invention may comprise antioxidants, UV absorbers and light stabilisers or blowing agents. Suitable antioxidants are described, for example, on pages 33 to 35 of EP-A 1 046 668. Suitable UV absorbers and light stabilisers are mentioned on pages 35 and 36 therein. Reference is expressly made here to both disclosures, the disclosures being regarded as part of the present text.

Suitable blowing agents are, for example, organic tetrazoles, oxazines, isatoic anhydride, salts of citric acid, for example ammonium citrate, and also sodium carbonate and sodium hydrogen carbonate. Especially suitable, for example, are ammonium citrate, sodium hydrogen carbonate or mixtures thereof.

A stabiliser composition according to the invention may also comprise impact strength modifiers and processing aids, gelling agents, antistatics, biocides, metal deactivators, optical brighteners, flame retardants and also antifogging compounds. Suitable compounds of those classes of compound are described, for example, in “Kunststoff Additive”, R. Kessler/H. Müller, Carl Hanser Verlag, 3rd edition, 1989 and also in “Handbook of PVC Formulating”, E. J. Wilson, J. Wiley & Sons, 1993.

In principle, a stabiliser composition according to the invention may be prepared in any manner by mixing together the individual components.

The present invention accordingly relates also to a process for the preparation of a stabiliser composition for stabilising halogen-containing thermoplastic resins, in which
a) calcium hydroxide or calcium oxide or a mixture of calcium hydroxide and calcium oxide as component A and
b) at least one β-diketone or a salt of a β-diketone or a mixture thereof as component B and
c) at least one hydroxyl-group-containing isocyanurate or a mixture of two or more hydroxyl-group-containing isocyanurates as component C
   are mixed with one another, component B containing less than 33% by weight, based on component B, of acetylacetone or a salt of acetylacetone or a mixture thereof.

The stabiliser compositions according to the invention are suitable for stabilising halogen-containing polymers.

Examples of such halogen-containing polymers are polymers of vinyl chloride, vinyl resins containing vinyl chloride units in the polymer backbone, copolymers of vinyl chloride and vinyl esters of aliphatic acids, especially vinyl acetate, copolymers of vinyl chloride with esters of acrylic and methacrylic acid or acrylonitrile or mixtures of two or more thereof, copolymers of vinyl chloride with diene compounds or unsaturated dicarboxylic acids or anhydrides thereof, for example copolymers of vinyl chloride with diethyl maleate, diethyl fumarate or maleic anhydride, post-chlorinated polymers and copolymers of vinyl chloride, copolymers of vinyl chloride and vinylidene chloride with unsaturated aldehydes, ketones and other compounds such as acrolein, crotonaldehyde, vinyl methyl ketone, vinyl methyl ether, vinyl isobutyl ether and the like, polymers and copolymers of vinylidene chloride with vinyl chloride and other polymerisable compounds, such as those already mentioned above, polymers of vinyl chloroacetate and dichlorodivinyl ether, chlorinated polymers of vinyl acetate, chlorinated polymeric esters of acrylic acid and of α-substituted acrylic acids, chlorinated polystyrenes, for example polydichlorostyrene, chlorinated polymers of ethylene, polymers and post-chlorinated polymers of chlorobutadiene and copolymers thereof with vinyl chloride and also mixtures of two or more of the mentioned polymers or polymer mixtures that contain one or more of the above-mentioned polymers. Within the scope of a preferred embodiment of the present invention, the stabiliser compositions according to the invention are used for the production of moulded articles of PVC-U, such as window profiles, industrial profiles, tubes and plates.

Also suitable for stabilisation with the stabiliser compositions according to the invention are the graft polymers of PVC with EVA, ABS or MBS. Preferred substrates for such graft copolymers are also the afore-mentioned homo- and co-polymers, especially mixtures of vinyl chloride homopolymers with other thermoplastic or elastomeric polymers, especially blends with ABS, MBS, NBR, SAN, EVA, CPE; MBAS, PAA (polyalkyl acrylate), PAMA (polyalkyl methacrylate), EPDM, polyamides or polylactones.

Likewise suitable for stabilisation with the stabiliser compositions according to the invention are mixtures of halogenated and non-halogenated polymers, for example mixtures of the above-mentioned non-halogenated polymers with PVC, especially mixtures of polyurethanes and PVC.

Furthermore, it is also possible for recyclates of chlorine-containing polymers to be stabilised with the stabiliser compositions according to the invention, in principle any recyclates of the above-mentioned halogenated polymers being suitable for that purpose. PVC recyclate, for example, is suitable in the context of the present invention.

The stabiliser composition according to the invention is used preferably for polyvinyl chloride (PVC) as halogen-containing thermoplastic resin. It is used, for example, for PVC-U (hard PVC). The term “polyvinyl chloride” used herein includes customary homopolymers and copolymers of vinyl chloride as well as mixtures of such polyvinyl choride compounds with other polymer compositions. Such polymers may have been prepared in any manner, for example by suspension polymerisation, emulsion polymerisation or block polymerisation. Their K value may be, for example, from 50 to 100.

It has been shown that, by using a stabiliser combination according to the invention, it is possible especially to produce moulded articles of PVC-U for outdoor applications that exhibit unexpectedly high stability to weathering and thermal stability and have outstanding processing properties.

The present invention accordingly relates also to a polymer composition comprising a stabiliser composition and at least one polymer, wherein there is present, as stabiliser composition, at least
a) calcium hydroxide or calcium oxide or a mixture of calcium hydroxide and calcium oxide as component A and
b) at least one β-diketone or a salt of a β-diketone or a mixture thereof as component B and
c) at least one hydroxyl-group-containing isocyanurate or a mixture of two or more hydroxyl-group-containing isocyanurates as component C
   and, as polymer,
d) a halogen-containing thermoplastic resin or a mixture of two or more halogen-containing thermoplastic resins,
   and wherein component B contains less than 33% by weight, based on component B, of acetylacetone or a salt of acetylacetone or a mixture thereof. A polymer composition according to the invention contains component A preferably in an amount of from 0.01 to 2 phr, based on the halogen-containing resin. A polymer composition according to the invention contains component B preferably in an amount of from 0.01 to 1 part by weight, based on the halogen-containing resin.

A polymer composition according to the invention preferably meets one or more of the following conditions:
(i) the content of component A is from 0.01 to 0.8 phr, based on the thermoplastic resin to be stabilised or the thermoplastic resins to be stabilised,
(ii) the content of component B is from 0.01 to 0.6 phr, based on the thermoplastic resin to be stabilised or the thermoplastic resins to be stabilised,
(iii) the content of component C is from 0.01 to 0.59 phr, based on the thermoplastic resin to be stabilised or the thermoplastic resins to be stabilised,
(iv) the content of component A is from 0.1 to 12% by weight, based on the total weight of the stabiliser composition,
(v) the content of component B is from 0.1 to 18% by weight, based on the total weight of the stabiliser composition,
(vi) the content of component C is from 0.1 to 15% by weight, based on the total weight of the stabiliser composition,
(vii) the ratio by weight of component B to component C is more than 1.

It has been found in accordance with the invention that especially good results can be achieved when the polymer composition contains component A in an amount of from 0.01 to 2 phr, based on the thermoplastic resin to be stabilised or the thermoplastic resins to be stabilised. Especially suitable proportions of component A lie, for example, within a range of from about 0.05 to about 1.0 phr, or within a range of from about 0.08 to about 0.8 phr. Also suitable, for example, are amounts of from about 0.1 to about 0.5 phr, for example from about 0.15 to about 0.45 phr or also from about 0.2 to about 0.4 phr or from about 0.25 to about 0.35 phr or from about 0.28 to about 0.32 phr. Within the scope of a preferred embodiment of the present invention, the content of component A is about 0.05 to 0.3299 phr, based on the thermoplastic resin to be stabilised or the thermoplastic resins to be stabilised.

Component B is preferably present in a polymer composition according to the invention in an amount of from about 0.01 to about 2 phr, based on the thermoplastic resin to be stabilised or the thermoplastic resins to be stabilised. Especially suitable amounts lie, for example, within a range of from about 0.03 to about 1.5 phr or from about 0.05 to about 1.2 phr or from about 0.08 to about 1 phr or from about 0.1 to about 0.9 phr or from about 0.15 to about 0.8 phr or from about 0.2 to about 0.7 phr. The content of component B is preferably about 0.2 to 0.6 phr, for example from about 0.3 to about 0.55 phr, based on the halogen-containing thermoplastic resin to be stabilised or the halogen-containing thermoplastic resins to be stabilised.

Component C is preferably present in a polymer composition according to the invention in an amount of from about 0.01 to about 3 phr, based on the thermoplastic resin to be stabilised or the thermoplastic resins to be stabilised. Especially suitable amounts lie, for example, within a range of from about 0.03 to about 2 phr or from about 0.05 to about 1.5 phr or from about 0.06 to about 1 phr or from about 0.08 to about 0.8 phr or from about 0.09 to about 0.5 phr or from about 0.1 to about 0.3 phr.

A polymer composition according to the invention preferably comprises a hydrotalcite or a mixture of two or more hydrotalcites. The scope of the invention also includes polymer compositions that comprise a zinc salt or a mixture of two or more zinc salts.

A polymer composition according to the invention comprises calcium acetylacetonate or zinc acetylacetonate or a mixture thereof preferably in an amount of less than 0.1 phr, based on the thermoplastic resin to be stabilised or the thermoplastic resins to be stabilised. Especially preferred amounts of calcium acetylacetonate or zinc acetylacetonate or a mixture thereof may be found in the present text in the context of the description of the stabiliser compositions according to the invention.

For a polymer composition according to the present invention, therefore, in terms of the stabiliser components present in such a polymer composition the statements already made in respect of the stabiliser composition apply. In the final analysis, the polymer compositions according to the present invention differ from the stabiliser compositions according to the invention in that the stabiliser compositions do not contain polymer. Otherwise, the properties of the stabiliser compositions present in the polymer composition and of the stabiliser compositions according to the invention are identical, so that the above statements in respect of the stabiliser compositions apply also to the stabiliser components present in the polymer compositions.

Within the scope of a preferred embodiment of the present invention, a polymer composition according to the invention contains the stabiliser composition according to the invention in an amount of about 0.1 to 20 phr, especially from about 0.5 to about 15 phr or from about 1 to about 12 phr or about 1.5 to 5 phr. The optimum amount for an individual case depends also on the glidants used. The unit phr represents “per hundred resin” and thus relates to parts by weight per 100 parts by weight of polymer. Suitable amounts for use lie, for example, within a range of about 2 to 3 phr or 3 to 4 phr including a proportion of processing aids.

A polymer composition according to the invention contains the stabiliser composition according to the invention in an amount of, for example, about 0.05 to 20% by weight or from about 0.1 to about 15% by weight or from about 0.5 to about 12% by weight or from about 1 to about 10% by weight or from about 1.3 to about 8% by weight or from about 1.5 to about 5% by weight based on the content of halogenated polymers.

Preferably, a polymer composition according to the invention contains, as halogenated polymer, at least a proportion of PVC, the proportion of PVC being especially at least about 20% by weight, preferably at least about 50% by weight, for example at least about 80% by weight or at least about 90% by weight.

The mixing of polymer or polymers and the stabiliser composition according to the invention to produce the polymer compositions according to the invention can, in principle, be carried out at any time before or during processing of the polymer. For example, the stabiliser composition can be mixed into the pulverulent or granular polymer prior to processing. It is equally possible, however, to add the stabiliser composition to the polymer or to the polymers in the softened or molten state, for example during processing in an extruder.

The present invention accordingly relates also to a process for the preparation of a polymer composition comprising a stabiliser composition and at least one polymer in which at least
a) calcium hydroxide or calcium oxide or a mixture of calcium hydroxide and calcium oxide as component A and
b) at least one β-diketone or a salt of a β-diketone or a mixture thereof as component B and
c) at least one hydroxyl-group-containing isocyanurate or a mixture of two or more hydroxyl-group-containing isocyanurates as component C and
d) at least one halogen-containing themoplastic resin or a mixture of two or more halogen-containing themoplastic resins
   are mixed with one another, component B containing less than 33% by weight, based on component B, of acetylacetone or a salt of acetylacetone or a mixture thereof.

The stabiliser composition according to the invention can be in any desired physical form, for example in the form of a powder mixture, compressed granules, spray granules or microgranules, flakes or pastilles or extrudate. Those product forms can either be made into granular form from powder mixtures by means of pressure and/or temperature and/or by the addition of granulating aids, or formed into flakes, pastilles or prills by cooling down or spraying melts of the composition according to the invention. In order to prepare halogen-containing resin compositions, the individual substances may be added directly or in the form of a mixture to the above-mentioned product forms prior to or during processing. The halogen-containing thermoplastic resin mass can then be formed in a manner known per se into moulded articles.

A polymer composition according to the invention can be brought into a desired form in known manner. Suitable methods are, for example, calendering, extrusion, injection-moulding, sintering, extrusion blowing or the plastisol process. A polymer composition according to the invention can also be used, for example, in the production of foamed materials. In principle, the polymer composition according to the invention is suitable for the production of hard or soft PVC.

A polymer composition according to the invention can be processed to form moulded articles. The present invention therefore relates also to moulded articles, at least comprising a stabiliser composition according to the invention or a polymer composition according to the invention.

The term “moulded article” in the context of the present invention in principle includes any three-dimensional structures that can be produced from a polymer composition according to the invention. In the context of the present invention the term “moulded article” includes, for example, wire sheathings, automobile components, for example automobile components such as are used in the interior of the automobile, in the engine space or on the outer surfaces, cable insulations, cable sheaths, decorative films, agricultural films, hoses, shaped sealing elements, office films, hollow bodies (bottles), packaging films (deep-draw films), blown films, tubes, foamed materials, heavy duty profiles (window frames), light wall profiles, structural profiles, sidings, fittings, plates, foamed panels, co-extrudates having a recycled core, or housings for electrical apparatus or machinery, for example computers or household appliances. Further examples of moulded articles that can be produced from a polymer composition according to the invention are synthetic leather, floor coverings, textile coatings, wall coverings, coil coatings and underseals for motor vehicles.

The present invention relates also to the use of a stabiliser composition according to the invention or of a stabiliser composition prepared in accordance with the invention or of a polymer composition according to the invention in the production of polymeric moulded articles or surface-coating compositions.

The invention relates especially to the use of a stabiliser composition for stabilising a halogen-containing thermoplastic resin or a mixture of two or more halogen-containing thermoplastic resins, the stabiliser composition at least comprising
a) calcium hydroxide or calcium oxide or a mixture of calcium hydroxide and calcium oxide as component A and
b) at least one β-diketone or a salt of a β-diketone or a mixture thereof as component B and
c) at least one hydroxyl-group-containing isocyanurate or a mixture of two or more hydroxyl-group-containing isocyanurates as component C,
   wherein component B contains less than 33% by weight, based on component B, of acetylacetone or a salt of acetylacetone or a mixture thereof.

The invention is explained in greater detail below by Examples:

### EXAMPLE 1

First, the reactivity of the individual components and the interaction of in each case two components were examined. For that purpose, in each case two components were mixed in the form of powder and treated for a total of 2 hours at 190° C. The reaction behaviour was then optically assessed at specific intervals.

TABLE 1
Reaction of in each case two components at 190° C./2 h

| | Ca-acetylacetonate | Stearoylbenzoylmethane |
|---|---|---|
| Irganox 1076* | − | + |
| Glycerol tristearate | − | + |
| THEIC | − | + |
| Stearoylbenzoylmethane | − | |

*phenolic antioxidant
− clear reactivity (black colouration)
+ no reactivity

It is evident from those tests that calcium acetylacetonate has a tendency to react with other stabiliser components with clear changes in colour and consistency. The colour changes go as far as a black colouration of the mixture. Stearolybenozylmethane, on the other hand, under the same reaction conditions, has no reaction with the same potential reactants and exhibits no change in colour or consistency.

### EXAMPLE 2

In addition, two-component mixtures were exposed to certain storage conditions and then examined in respect of use-related properties. The following storage conditions were applied: room temperature, room temperature and 80% relative humidity, 45° C., and also 45° C. and 80% relative humidity. The Table below gives an overview of the mixtures used and the colour and consistency thereof after one month's storage under the conditions in question.

TABLE 2
Storage stability of two-component mixtures

| | | 23° C., | | 45° C., |
|---|---|---|---|---|
| | 23° C. | 80% H₂O | 45° C. | 80% H₂O |
| Irganox 1076*/calcium | 1 | 1 | 5 | 5 |
| acetylacetonate | | | | |
| Glycerol tristearate/ | 1 | 1 | 2 | 4 |
| calcium acetylacetonate | | | | |
| Stearoylbenzoylmethane/ | 3 | 4 | 5 | 6 |
| calcium acetylacetonate | | | | |

*phenolic antioxidant
1 white powder
2 white caked powder
3 slight yellow tinge
4 slight yellow tinge and tacky
5 yellow and markedly tacky, or yellowish brown and powdery
6 yellowish brown, tacky and solid

The combination of stearoylbenzoylmethane and calcium acetylacetonate, which after a month's storage at 45° C. and 80% humidity exhibited a yellowish brown colouration and a tacky consistency, proved to be especially critical, but also the mixtures of calcium acetylacetonate with phenolic antioxidant or with glycerol tristearate exhibit marked changes in colour and consistency at higher storage temperature and humidity.

### EXAMPLE 3

In addition, the discoloration of the stabiliser mixture occurring during storage also has an adverse affect on the colour of the extruded profile. In order to demonstrate that, a two-component mixture of stearoylbenzoylmethane and calcium acetylacetonate stored at 45° C. and 80% humidity was used to produce a PVC testpiece. The colour of the PVC testpiece was then ascertained using the CIE-LAB colour system.

TABLE 3
Affect of the storage-determined colour properties of a stabiliser
mixture of stearoylbenzoylmethane and calcium
acetylacetonate on the colour of the extruded profile

| | untreated standard | 45° C., 80% H₂O |
|---|---|---|
| L | 94.60 | 93.94 |
| a | 0.78 | 0.86 |
| b | 4.14 | 6.56 |

Table 3 shows that the storage of the stabiliser mixture clearly worsens all three CIE-LAB values of the PVC testpiece produced therewith.

### EXAMPLE 4

In order to examine the activity of the stabiliser compositions according to the invention, the formulations indicated in the following Table 3 were prepared. Formulation A1 corresponds to a composition according to the invention, whereas formulations V1, V2 and V3 were tested for comparison purposes.

TABLE 4.1
Example formulations

| | V1 | V2 | V3 | A1 |
|---|---|---|---|---|
| PVC, K 60 | 100 | 100 | 100 | 100 |
| Zinc stearate | 0.2 | 0.2 | 0.2 | 0.2 |
| Zinc octoate | 0.2 | 0.2 | 0.2 | 0.2 |
| Alcamizer 4 | 0.6 | 0.6 | 0.6 | 0.6 |
| THEIC | 0.1 | 0.1 | 0.1 | 0.1 |
| Pentaerythritol | 0.5 | 0.5 | 0.5 | 0.5 |
| Pentaerythritol distearate | 0.5 | 0.5 | 0.5 | 0.5 |
| Stearoylbenzoylmethane | 0.1 | 0.5 | 0.1 | 0.5 |
| Calcium acetylacetonate | 0.4 | | 0.4 | |
| Calcium stearate | 0.25 | 0.25 | | |
| Calcium hydroxide | | | 0.25 | 0.25 |

The dryblends prepared according to the formulations specified were processed on a roll mill to form rolled sheets and compressed to form pressed plates (1 mm). The PVC testpieces so obtained were subjected to a DHC test according to DIN 53381 part 1, process B and to a Mathis test at 200° C. (5 min steps). In addition, with the pressed plates the initial colour of the transparent specimens was measured in front of a white background using the CIE-LAB colour system. The results of the tests are shown in Table 4.2 below.

TABLE 4.2
Test results

| | | V1 | V2 | V3 | A1 |
|---|---|---|---|---|---|
| Stat. stability | DHC stability | 32 | 22 | 35 | 29 |
| Initial colour | L* value | 83.35 | 83.2 | 81.21 | 85.57 |
| | a* value | −3.13 | −1.49 | −4.90 | −1.88 |
| | b* value | 14.62 | 8.12 | 22.69 | 7.49 |
| Mathis test | start of yellow discolouration | 5 | 20 | 15 | 20 |
| | [min] | | | | |
| | Start of brown discolouration | 35 | 30 | 30 | 35 |
| | [min] | | | | |

Table 4.2 shows that a stabiliser composition according to the invention delivers a good DHC stability. In addition to that, the stabiliser composition according to the invention has the best values for the white and yellow components (L and +b* values) of the initial colour. Furthermore, the stabiliser composition according to the invention has a very good thermal stability. This is shown by the results of the Mathis test, in which the stabiliser composition according to the invention has the highest colour stability as an individual stabiliser composition both until the yellow discolouration commences and until the brown discolouration commences.

1. A stabiliser composition for stabilising one or more halogen-containing thermoplastic resins, comprising:
a) calcium hydroxide, calcium oxide, or a mixture of calcium hydroxide and calcium oxide as component A and
b) at least one β-diketone, at least one salt of a β-diketone, or a mixture thereof as component B; and
c) at least one hydroxyl-group-containing isocyanurate or a mixture of two or more hydroxyl-group-containing isocyanurates as component C,
wherein component B contains less than 33% by weight, based on component B, of acetylacetone, acetylacetone salts or mixtures thereof.

2. The stabiliser composition according to claim 1, wherein component B contains less than 20% by weight, based on component B, of acetylacetone, acetylacetone salts or mixtures thereof.

3. The stabiliser composition according to claim 1, wherein component A is present in an amount of from 0.01 to 2 phr, based on the one or more thermoplastic resins to be stabilised.

4. The stabiliser composition according to claim 1, wherein the hydroxyl-group-containing isocyanurate is selected from compounds of the general formula (I) 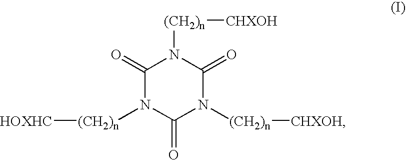
wherein the groups X and the indices n are identical or different and n is an integer from 0 to 5 and X is a hydrogen atom or a linear or branched alkyl group having from 1 to 6 carbon atoms.

5. The stabiliser composition according to claim 1, wherein one or more of the following conditions are met:
(i) the content of component A is from 0.01 to 0.8 phr, based on the one or more thermoplastic resins to be stabilised,
(ii) the content of component B is from 0.01 to 0.6 phr, based on the one or more thermoplastic resins to be stabilised,
(iii) the content of component C is from 0.01 to 0.59 phr, based on the one or more thermoplastic resins to be stabilised, and
(iv) the ratio by weight of component B to component C is more than 1.

6. The stabiliser composition according to claim 1, wherein one or more of the following conditions are met:
(i) the content of component A is from 0.1 to 12% by weight, based on the total weight of the stabiliser composition,
(ii) the content of component B is from 0.1 to 18% by weight, based on the total weight of the stabiliser composition,
(iii) the content of component C is from 0.1 to 15% by weight, based on the total weight of the stabiliser composition, and
(iv) the ratio by weight of component B to component C is more than 1.

7. The stabiliser composition according to claim 1, further comprising a hydrotalcite or a mixture of two or more hydrotalcites.

8. The stabiliser composition according to claim 1, further comprising a zinc salt or a mixture of two or more zinc salts.

9. The stabiliser composition according to claim 1, further comprising a mixture of zinc stearate and at least one further organic zinc carboxylate.

10. The stabiliser composition according to claim 1, further comprising calcium acetylacetonate, zinc acetylacetonate, or a mixture thereof in an amount of less than 0.1 phr, based on the one or more thermoplastic resins to be stabilised.

11. The stabiliser composition according to claim 1, further comprising a triglyceride.

12. A polymer composition, comprising a stabiliser composition and at least one polymer, said stabiliser composition comprising:
a) calcium hydroxide, calcium oxide, or a mixture of calcium hydroxide and calcium oxide as component A and
b) at least one β-diketone, at least one salt of a β-diketone, or a mixture thereof as component B; and
c) at least one hydroxyl-group-containing isocyanurate or a mixture of two or more hydroxyl-group-containing isocyanurates as component C
and the at least one polymer comprising
d) a halogen-containing themoplastic resin or a mixture of two or more halogen-containing themoplastic resins,
wherein component B contains less than 33% by weight, based on component B, of acetylacetone, acetylacetone salts or mixtures thereof.

13. The polymer composition according to claim 12, wherein component A is present in an amount of from 0.01 to 2 phr, based on the at least one polymer.

14. The polymer composition according to claim 12, wherein component B is present in an amount of from 0.01 to 1 part by weight, based on the at least one polymer.

15. The polymer composition according to claim 12, wherein one or more of the following conditions are met:
(i) the content of component A is from 0.01 to 0.8 phr, based on the at least one polymer,
(ii) the content of component B is from 0.01 to 0.6 phr, based on the at least one polymer,
(iii) the content of component C is from 0.01 to 0.59 phr, based on the at least one polymer, and
(iv) the ratio by weight of component B to component C is more than 1.

16. The polymer composition according to claim 12, wherein one or more of the following conditions are met:
(i) the content of component A is from 0.1 to 12% by weight, based on the total weight of the stabiliser composition,
(ii) the content of component B is from 0.1 to 18% by weight, based on the total weight of the stabiliser composition,
(iii) the content of component C is from 0.1 to 15% by weight, based on the total weight of the stabiliser composition, and
(iv) the ratio by weight of component B to component C is more than 1.

17. The polymer composition according to claim 12, further comprising a hydrotalcite or a mixture of two or more hydrotalcites.

18. The polymer composition according to claim 12, further comprising a zinc salt or a mixture of two or more zinc salts.

19. The polymer composition according to claim 12, further comprising calcium acetylacetonate, zinc acetylacetonate or a mixture thereof in an amount of less than 0.1 phr, based on the at least one polymer.

20. A process for the preparation of a stabiliser composition for stabilising one or more halogen-containing thermoplastic resins, wherein
a) calcium hydroxide, calcium oxide or a mixture of calcium hydroxide and calcium oxide as component A
b) at least one β-diketone, at least one salt of a β-diketone or a mixture thereof as component B and
c) at least one hydroxyl-group-containing isocyanurate or a mixture of two or more hydroxyl-group-containing isocyanurates as component C
are mixed with one another, component B containing less than 33% by weight, based on component B, of acetylacetone, acetylacetone salts or mixtures thereof.

21. A process for the preparation of a polymer composition comprising a stabiliser composition and at least one polymer, wherein
a) calcium hydroxide, calcium oxide or a mixture of calcium hydroxide and calcium oxide as component A and
b) at least one β-diketone, at least one salt of a β-diketone or a mixture thereof as component B and
c) at least one hydroxyl-group-containing isocyanurate or a mixture of two or more hydroxyl-group-containing isocyanurates as component C and
d) a halogen-containing themoplastic resin or a mixture of two or more halogen-containing themoplastic resins
are mixed with one another, component B containing less than 33% by weight, based on component B, of acetylacetone, acetylacetone salts or mixtures thereof.

22. A method of stabilising at least one halogen-containing thermoplastic resin, wherein a stabiliser composition and at least one halogen-containing thermoplastic polymer are mixed together, the stabiliser composition comprising
a) calcium hydroxide, calcium oxide or a mixture of calcium hydroxide and calcium oxide as component A and
b) at least one β-diketone, at least one salt of a β-diketone or a mixture thereof as component B and
c) at least one hydroxyl-group-containing isocyanurate or a mixture of two or more hydroxyl-group-containing isocyanurates as component C,
wherein component B contains less than 33% by weight, based on component B, of acetylacetone, of acetylacetone salts or mixtures thereof.

23. A moulded article, comprising a stabiliser composition according to claim 1.

24. (canceled)

25. A moulded article, comprising a polymer composition according to claim 12.
